(19) United States
(12) Patent Application Publication
(10) Pub. No.: US 2025/0280234 A1
(43) Pub. Date: Sep. 4, 2025

(54) AUDIO FEEDBACK DETECTION AND SUPPRESSION METHOD FOR A WEARABLE AUDIO DEVICE

(71) Applicant: Absolute Audio Labs B.V., Leiden (NL)

(72) Inventor: Johannes LIJZENGA, Leiden (NL)

(21) Appl. No.: 18/857,916

(22) PCT Filed: Apr. 20, 2023
(86) PCT No.: PCT/NL2023/050212

§ 371 Date: Oct. 18, 2024

(30) Foreign Application Priority Data
Apr. 20, 2022 (NL) 2031644

(51) Int. Cl. H04R 3/02; H04R 1/10; H04R 29/00

(52) U.S. Cl. CPC H04R 3/02; H04R 1/1041; H04R 29/001

(57) ABSTRACT

The disclosure relates to a method and wearable audio device for detecting an audio feedback condition in an audio signal. The method comprises receiving a series of time frames of a time-domain audio signal, each pair of consecutive time frames of the series of time frames being, at least partly, shifted in time by a time interval; determining in a frequency domain, a phase spectrum for each time frame over a plurality of frequency bands; for each frequency band of the plurality of frequency bands, determining a phase correlation across the determined phase spectra, and generating a pure tone detection signal in case a predefined phase correlation criterion is met.

### FIELD

The invention relates to a method for detecting and suppressing audio feedback in a wearable audio device.

### BACKGROUND

Audio feedback in wearable audio devices, such as hearing aids, occurs when a sound loop is formed between an output element, such as a speaker, and an input element, such as a microphone. A signal picked up by the input element may be amplified by the audio device and passed out by the output element. When the input element picks up the passed out amplified signal again, it is further amplified and passed out again, thus creating a positive feedback loop. Such audio feedback is noticeable as uncomfortable whistling sound, generally at mid-to high frequencies, well known to users of hearing aids.

### SUMMARY

It is an aim to rapidly detect and suppress audio artifacts, particularly audio feedback, in an audio signal, while limiting computational cost.

According to an aspect, a method of detecting an audio feedback condition in a wearable audio device is provided. The method comprises receiving a series of time frames of a time-domain audio signal, each pair of consecutive time frames of the series of time frames being, at least partly, shifted in time by a time interval; determining in a frequency domain, a phase spectrum for each time frame over a plurality of frequency bands; for each frequency band of the plurality of frequency bands, determining a phase correlation across the determined phase spectra, and generating a feedback detection signal in case a predefined phase correlation criterion is met.

The method enables detection of pure tones in the audio signal that are sustained over time. The presence of a pure tone at a particular frequency band may indicate a sustained oscillation at that frequency band, and may hence indicate the occurrence of audio feedback at that frequency.

Hence, the aspect may particularly provide a method of detecting a presence of an audio feedback condition in an audio signal for a wearable audio device, comprising receiving a series of time frames of a time-domain audio signal, each pair of consecutive time frames of the series of time frames being, at least partly, shifted in time by a time interval; and detecting a presence of a pure tone in the series of time frames. The detecting of the presence of the pure tone includes: determining in a frequency domain, a phase spectrum for each time frame over a plurality of frequency bands; for each frequency band of the plurality of frequency bands, determining a phase correlation across the determined phase spectra. The method comprises generating a pure tone detection signal in case a predefined phase correlation criterion is met. The detected pure tone may be indicative of a feedback condition in the audio signal. Hence, the pure tone detection signal may prompt a processing of the audio signal to eliminate the audio feedback from the audio signal. The pure tone detection signal may particularly prompt a determination of whether the pure tone originates from audio feedback or not.

For each frequency band, the phase spectrum of the audio signal may be monitored over time, wherein certain time-based phase development patterns can indicate the presence of a sustained pure tone at that frequency band. The detection signal may thus be generated in case a predefined temporal behavior of the phase across the phase spectra is determined. In absence of audio feedback, the phase changes perceptively random over time, for each frequency band. Correlating phase information of consecutive time frame signals with each other, may be indicative of whether or not the phase of the audio signal at a particular frequency band is random or not. Thus, correlating phase information of consecutive time frame signals with each other, may be indicative of whether or not audio feedback is present at a particular frequency band. Hence, the pure tone detection signal may be generated in case a non-random phase correlation is determined. For example, at a constant sampling rate, a phase value at a frequency band developing linearly over time may indicate the presence of audio feedback at that frequency band. For instance, at a constant sampling rate, a phase value at a frequency band being constant over time may indicate the presence of audio feedback at that frequency band. Hence, in a particular example, the phase correlation criterion may be met in case, for a particular frequency band, a phase value change over time between a number of consecutive time frames is constant.

Each time frame signal may be defined by multiple time-samples of the audio signal. Consecutive time frame signals may be partly overlapping, i.e. have a number of time-samples in common, or may be non-overlapping. The phase correlation may for example be determined over one to ten consecutive time frames, such as 2-8 consecutive time frames, for example over 3, 4, 5, 6 or 7 consecutive time frames

The method for example comprises receiving a first time frame signal and a second time frame signal of a time-domain audio signal, the second time frame signal being, at least partly, shifted in time from the first time frame signal by a time interval; determining in a frequency domain, a first phase spectrum of the first time frame and a second phase spectrum of the second time frame over a plurality of corresponding frequency bands; for each frequency band of the plurality of corresponding frequency bands, determining a phase correlation between the first phase spectrum and the second spectrum; and generating a feedback detection signal or a pure tone detection signal in case a predefined phase correlation criterion is met for at least one of the frequency bands. A frequency band at which the predefined phase correlation criterion is met indicates the presence of a pure tone in the audio signal, in turn indicating a potential presence of an audio feedback condition in the audio signal. A frequency band at which the predefined phase correlation criterion is met, herein, is also referred to as a feedback frequency band.

The detected pure tone may originate from audio feedback. However, the detected pure tone may also originate from a recorded pure tone in the environment, i.e. not from a feedback condition. It may be preferred to suppress the pure tone originating from audio feedback, while not suppressing recorded external pure tones. The method may therefore optionally comprise, in case a pure tone detection signal is generated, interacting with audio signal in the frequency domain, e.g. with the magnitude and/or the phase, for determining whether the detected pure tone originates from audio feedback. The method may for example comprise selectively suppressing the magnitude of the audio signal at said feedback frequency band, such as below unity gain; monitoring the suppressed magnitude and/or the phase of the audio signal at the feedback frequency band over a further series of time frames, such as over 2 to 6 consecutive time frames; and determining whether the detected pure tone is sustained in the further series of time frames based on the monitored magnitude and/or phase. It will be appreciated that a phase correlation and/or a magnitude correlation can be determined from the monitoring of the phase over the consecutive time frames. The method may optionally comprise eliminating or relieving the suppressing in case the pure tone is sustained, despite the suppressing.

It may be determined that the detected pure tone originates from a recorded pure tone in the environment of the user if, despite suppressing the magnitude of the audio signal at the feedback frequency band, particularly below unity gain, the pure tone is sustained in the audio signal. Hence, suppressing can be relieved or terminated in case it is determined that detected pure tone does not originate from audio feedback. On the other hand, it can be determined that the detected pure tone originates from audio feedback in case the suppressing, particularly below unity gain, eliminates the pure tone.

Whether the pure tone is sustained in the audio signal, or whether the suppressing breaks the audio feedback loop, may be determined by monitoring the magnitude of the audio signal at the feedback frequency band. If the audio feedback loop is broken by suppressing the magnitude at the feedback frequency band, particularly below unity gain, the pure tone may be eliminated from the audio signal entirely, which may be determined from the magnitude at the feedback frequency band dying out. Whether the pure tone is sustained in the audio signal, or whether the suppressing breaks the audio feedback loop, may additionally or alternatively be determined by monitoring the phase of the audio signal over the consecutive time frames at the feedback frequency band, e.g. the phase correlation. If, despite the suppressing, the phase correlation over the consecutive time frames indicates a nonrandom, e.g. a constant or linear, phase development of the phase at the feedback frequency band, it may be determined that the pure tone is still present in the audio signal, and hence that the detected pure tone does not originate from audio feedback. The suppressing may consequently be relieved accordingly.

Optionally, the phase correlation is determined, while accounting for a phase change corresponding to the time interval between each pair of consecutive time frames. During the time interval, the audio signal has developed, wherein, if audio feedback is present in the audio signal at a particular frequency, the phase development of the audio signal at that frequency may be predictable. An expected phase change of the audio signal in case feedback is present, can hence be accounted for. The expected phase change may for example be subtracted from the determined phase spectrum of a current time frame signal, and compared to a previous phase spectrum. For example, in case, at a particular frequency band, the current phase value reduced by the expected phase change equals, at least substantially, a previous phase value, feedback at said frequency band may be present.

Optionally, in case the phase associated with a frequency band is substantially equal across all phase spectra, within a predefined correlation range, a pure tone detection signal is generated. The correlation range may account for uncertainties in the computations, for example arising from noise and digital processing.

Optionally, the method comprises, in case the predefined phase correlation criterion is met for a frequency band, determining a magnitude value for each time frame at said frequency band, and determining a magnitude correlation across the determined magnitude values at said frequency band, and generating the pure tone detection signal only in case a predefined magnitude correlation criterion is met.

Optionally, the method comprises determining a magnitude spectrum for each time frame and, in case the predefined phase correlation criterion is met for a feedback frequency, determining a magnitude correlation across the determined magnitude spectra at the feedback frequency, and generating the pure tone detection signal only in case a predefined magnitude correlation criterion is met. Feedback, e.g. indicated by a presence of a pure tone in the audio signal, may be ascertained by correlating the phase spectra across the series of time frame signals alone, but accuracy and reliability of the detection method may be increased by also correlating the magnitude spectra across the series of time frame signals. The phase correlation over time may hence identify a candidate frequency band where feedback may be present, wherein a magnitude correlation over time at the candidate frequency band may provide additional information. For example, a rapidly increasing magnitude of the audio signal across consecutive time frame signals at a candidate frequency band, could, in view of the already identified phase correlation, corroborate the development of feedback at the candidate frequency. Also, a constant magnitude across consecutive time frame signals at the candidate frequency band could corroborate the presence of a feedback condition at the candidate frequency band.

Optionally, the series of time frame signals spans a time period of between 2-50 milliseconds. Each time frame may for example be, or span, at most 25 milliseconds, such as at most 22 milliseconds, for example between 2 and 22 or between 2 and 20 milliseconds.

Optionally, the series of time frame signals includes at least 3 time frame signals, preferably at least 4 time frame signals, more preferably at least 6 time frame signals.

Optionally, each phase spectrum, and each magnitude spectrum, is obtained by a 2N-point Fast Fourier Transform (FFT) of a respective time frame, and divided into N frequency bands. N is positive integer, preferably a power of two, such as 64, 128, 256, 512, 1024.

According to a further aspect, a method of suppressing an audio feedback condition in a wearable audio device is provided. The method comprises detecting an audio feedback condition in the wearable audio device as described herein; and, in case an audio feedback condition is detected at a feedback frequency band, selectively suppressing the magnitude of the audio signal at said feedback frequency band. The further aspect hence particularly provides a method of suppressing an audio feedback condition in a wearable audio device comprising detecting a pure tone in the wearable audio device as described herein; and, in case the pure tone is detected at the feedback frequency band, selectively suppressing the magnitude of the audio signal at said feedback frequency band. It will be appreciated that the method for detecting an audio feedback condition may be continued for the remaining frequency bands in case feedback is detected in one or more of the frequency bands.

Optionally, the magnitude of the audio signal at the feedback frequency band is suppressed below unity gain.

Optionally, the method comprises monitoring the suppressed magnitude and/or the phase of the audio signal at the feedback frequency band over a further series of time frames, such as over 2 to 6 consecutive time frames; determining whether the detected pure tone is sustained in the further series of time frames based on the monitored magnitude and/or phase; and eliminating or relieving the suppressing in case the pure tone is sustained. If, despite suppressing the magnitude of the audio signal at the feedback frequency band, particularly below unity gain, the pure tone is sustained, it can be determined that the detected pure tone originates from a recorded external pure tone in the environment of the user. Such detected pure tones may accordingly not originate from audio feedback, and are therefore preferably not attenuated.

It may be determined that the detected pure tone originates from a recorded pure tone in the environment of the user if, despite suppressing the magnitude of the audio signal at the feedback frequency band, particularly below unity gain, the pure tone is sustained. Hence, suppressing can be relieved or terminated in case it is determined that detected pure tone does not originate from audio feedback. On the other hand, it can be determined that the detected pure tone originates from audio feedback in case the suppressing, particularly below unity gain, eliminates the pure tone.

Whether the pure tone is sustained in the audio signal, or whether the suppressing breaks the audio feedback loop, may be determined by monitoring the magnitude of the audio signal at the feedback frequency band. If the audio feedback loop is broken by suppressing the magnitude at the feedback frequency band, particularly below unity gain, the pure tone may be eliminated from the audio signal entirely, which may be determined from the magnitude at the feedback frequency band dying out. Whether the pure tone is sustained in the audio signal, or wither the suppressing breaks the audio feedback loop, may additionally or alternatively be determined by monitoring the phase of the audio signal over the consecutive time frames at the feedback frequency band, e.g. the phase correlation. If, despite the suppressing, the phase correlation over the consecutive time frames indicates a nonrandom, e.g. a constant or linear, phase development of the phase at the feedback frequency band, it may be determined that the pure tone is still present in the audio signal, and hence that the detected pure tone does not originate from audio feedback. The suppressing may consequently be relieved accordingly.

Optionally, the magnitude of the audio signal is suppressed at one or more frequency bands adjacent said feedback frequency band.

Optionally, the magnitude of the audio signal is suppressed by filtering the audio signal with a notch-filter centered at said feedback frequency band.

Optionally, the magnitude at said feedback frequency band is suppressed for a predefined time period, and the suppression is released upon expiry of the predefined time period.

Optionally, the suppression is released upon detecting a predetermined maximum number of new audio feedback conditions.

Optionally, the maximum number of new audio feedback condition detections is predetermined to be in a predetermined range, e.g. between one and ten.

Optionally, the maximum number of new audio feedback condition detections is automatically adjustable.

Optionally, the magnitude of the audio signal at said feedback frequency band is permanently suppressed in case a feedback condition is determined again at a said feedback frequency band within a predefined time period after release of the suppression. Hence, repeatedly or continuously occurring feedback conditions at some particular frequency bands can be suppressed for an indefinite amount of time.

Optionally, the suppression tracks a frequency shift of the feedback frequency band. The feedback frequency at which feedback occurs may change slightly, for example when acoustics of the audio device and its surroundings changes, e.g. when a user puts on a hat or moves a phone close to its ear. In such case, the feedback frequency may shift from one frequency band to an adjacent frequency band. Hence, the wearable audio device may be configured to track a feedback frequency band shift for permanently suppressed frequency bands, and/or of temporarily suppressed frequency bands.

A further aspect provides a wearable audio device, comprising an audio feedback detection module configured for detecting an audio feedback condition in an audio signal according to a method as described herein. The wearable audio device may include an in-ear component, e.g. an earbud, for being inserted into a hearing canal of a user. The wearable audio device may for instance be a hearing aid, or an earphone, e.g. an in-earphone, on-earphone, or over-earphone, for playing music.

Optionally, the wearable audio device, comprising an audio feedback suppression module configured for suppressing audio feedback according to method as described herein.

It will be appreciated that any of the aspects, features and options described herein can be combined. It will particularly be appreciated that any of the aspects, features and options described in view of the methods apply equally to the wearable hearing device, and vice versa.

### BRIEF DESCRIPTION OF THE DRAWINGS

Embodiments of the present invention will now be described in detail with reference to the accompanying drawings in which:

FIG. 1 shows an example of an audio processing unit for a wearable audio device;

FIG. 2 shows an example of a wearable audio device; and

FIG. 3 shows an example of a flow chart.

### DETAILED DESCRIPTION

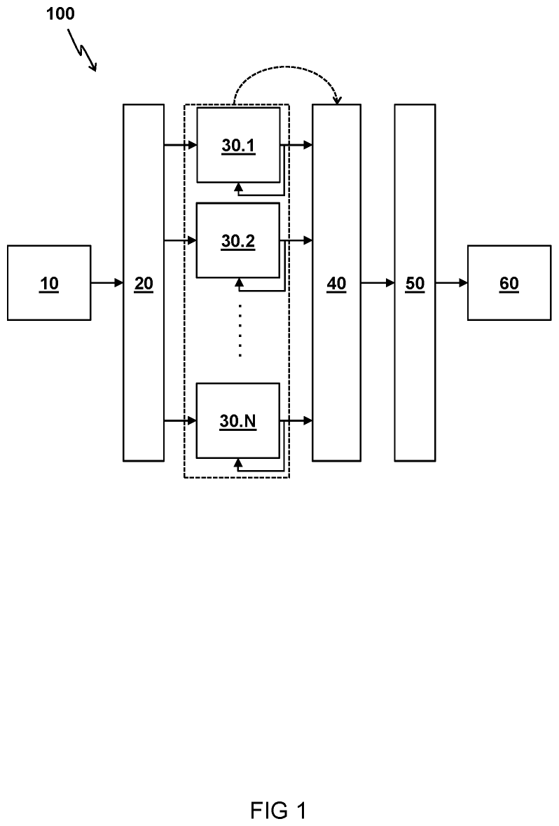

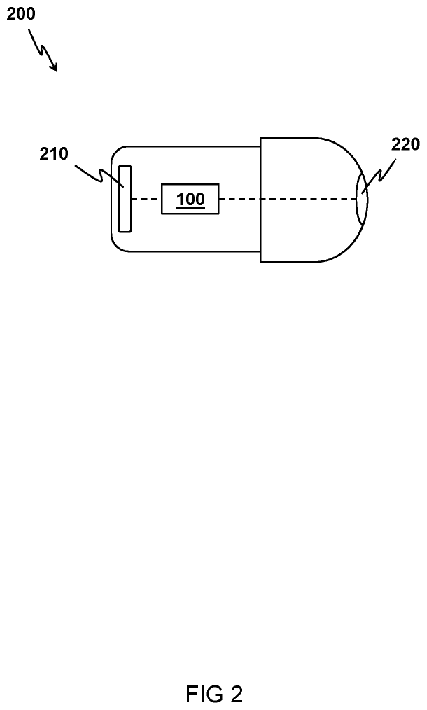

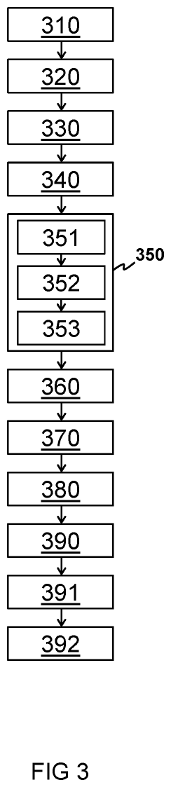

FIG. 1 shows a schematic example of a processing unit 100 for a wearable audio device, particularly for a hearing aid, an earphone, e.g. an in-earphone, on-earphone, or over-earphone. FIG. 2 shows an example of a wearable audio device 200, such as a hearing aid, an earphone, e.g. an in-earphone, on-earphone, or over-earphone. FIG. 2 particularly shows an in-earphone for being inserted into a hearing canal of a user. FIG. 3 shows an example of a flow chart of a method of detecting an audio feedback condition in a wearable audio device. The processing unit 100 comprises an analog to digital converter 10 configured for receiving 310 an analog audio signal, e.g. from a microphone 210 of the wearable audio device 200, and converting 320 the analog audio signal to a digital audio signal. The audio signal is divided 330 into multiple time frame signals. For example the digital audio signal may be divided into successive time frame signals, either overlapping or non-overlapping, that are shifted in time by a predetermined time period. Each time frame signal may be represented by a finite number of samples, particularly 2N samples wherein 2N is a power of 2, such as 256 or 512. The digital time frame signals are in this example processed consecutively through a single processing channel of the processing unit 100.

A frequency spectrum of each time frame signal is determined 340 by a first transformation module 20. The first transformation module particularly determines a Fourier transform of the time domain audio signal, e.g. implemented by a Fast Fourier Transform (FFT) algorithm. The frequency spectrum is determined over a plurality of different frequency bands, particularly over N different frequency bands, wherein N is preferably at least 256. It is determined, for each frequency band separately, whether or not a pure tone is present in the audio signal. The presence of a pure tone can originate from an audio feedback condition in the audio signal. It is thus determined, for each frequency band separately, whether or not audio feedback is present in the audio signal.

The processing unit 100 further comprises a feedback detection module 30 for detecting 350 a feedback condition in the audio signal. The feedback detection module, includes a plurality of feedback detectors 30.1-30.N. Each feedback detector 30.n can be linked to a frequency band of the frequency spectrum of the audio signal, and is configured to detect a pure tone indicative of a feedback condition in any respective frequency band.

Each feedback detector 30.n is particularly configured to monitor 351 a phase development of the frequency spectrum over time, e.g. over multiple consecutive time frame signals of the audio signal. Each feedback detector 30.n may for example be configured to compare a phase value corresponding to a current time frame signal with a phase value of a previous time frame signal. Audio feedback may be ascertained at a particular frequency band in case a phase value at that frequency band develops over time according to a predefined pattern. For example, each feedback detector 30.n may be configured to determine whether or not the phase develops linearly over time, e.g. by monitoring a difference between a phase value of a previous time frame signal and the phase value of a current time frame signal. In case the difference between consecutive time frame signals remains constant, e.g. within a predefined range, the presence of a feedback in the audio signal may be ascertained.

Development of the phase value for a particular frequency band may be predictable, given the time period between consecutive time frame signals of the audio signal. Hence, a phase change at each frequency band from one time frame signal to the next may be predictable for audio feedback signals, and accounted for by the feedback detection module 30. Such phase change may be frequency dependent. The feedback detection module 30 may for example be configured to adaptively determine a frequency phase change associated with audio feedback signals. An expected phase change associated with audio feedback may for instance be subtracted from each time frame signal phase value, wherein audio feedback can be detected in case the resultant phase values remain substantially constant over time.

To improve accuracy, the feedback detectors 30.n may further be configured to monitor 352 a magnitude development of the frequency spectrum over time, e.g. over multiple consecutive time frame signals of the audio signal. Correlating phase values over time may for example detect a candidate frequency band where audio feedback may be present, wherein, e.g. after having detected the candidate frequency, a magnitude correlation over time can be executed to affirm the presence of audio feedback at that candidate frequency band. For example, each feedback detector 30.n may be configured to monitor a magnitude value of the frequency spectrum over time. A constant magnitude across consecutive time frame signals at the candidate frequency band, e.g. a constant magnitude of approximately unity, could corroborate the presence of a feedback condition at the candidate frequency band.

The feedback detection module 30 may further be configured to generate 353 a pure tone detection signal in case a feedback condition has been detected by any one of the feedback detectors 30.n. The pure tone detection signal may be transmitted 360 to a feedback suppressor module 40 of the processing unit 100. The pure tone detection signal may particularly include information indicative of a frequency band at which a feedback condition has been detected.

The feedback suppression module 40 may receive 370 the pure tone detection signal and suppress 380 the feedback from the audio signal, such as below unity gain. The feedback suppression may particularly be executed in the frequency domain by suppressing a magnitude of the audio signal at the frequency band where the pure tone, i.e. the potential audio feedback, has been detected, e.g. by applying a adaptive digital filter to the frequency spectrum of the audio signal. The feedback suppression module 40 may for instance filter the frequency spectrum of the audio signal with a notch filter centered at the frequency band wherein audio feedback has been detected by the feedback detection module 30. The notch filter may cover multiple frequency bands, i.e. a bandwidth of the notch filter may be larger than a single frequency band.

By monitoring the suppressed magnitude and/or the phase at the feedback frequency band over time, such as over a further series of 2 to 6 consecutive time frames, it can be determined whether the detected pure tone indeed originated from an audio feedback condition. If, however, despite suppressing the magnitude of the audio signal at the feedback frequency band, the magnitude does not die out, it can be determined that the detected pure tone does not originate from audio feedback, but that it is for example recorded in the environment of the user. The suppressing may in such case be terminated or relieved accordingly. Suppressing the magnitude of the audio signal at the feedback frequency band, particularly below unity gain, may break the audio feedback loop, and may cause the detected pure tone to die out entirely. This could be observed from the monitoring of the magnitude at the feedback frequency band. It can additionally or alternatively be determined from the monitored phase that, if the phase correlation becomes randomized, the audio feedback loop is broken. If the phase correlation remains nonrandom, e.g. a constant or linear however, despite the suppressing of the magnitude below unity gain, it can be ascertained that the pure tone is still present in the audio signal, and hence that the detected pure tone does not originate from audio feedback.

The resultant frequency domain audio signal is subsequently converted back 390 to the time domain by a second transformation module 50, here by applying an Inverse Fast Fourier Transform (IFFT) algorithm. The resultant digital time-domain audio signal is, here, converted 391 to an analog audio signal by a digital-to-analog converter 60, e.g. to be transmitted 392 to an output speaker 220.

Herein, the invention is described with reference to specific examples of embodiments of the invention. It will, however, be evident that various modifications and changes may be made therein, without departing from the essence of the invention. For the purpose of clarity and a concise description, features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

For the purpose of clarity and a concise description, features are described herein as part of the same or separate embodiments, however, it will be appreciated that the scope of the invention may include embodiments having combinations of all or some of the features described.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A method of detecting an audio feedback condition in a wearable audio device, comprising:
receiving a series of time frames of a time-domain audio signal, each pair of consecutive time frames of the series of time frames being, at least partly, shifted in time by a time interval,
detecting a presence of a pure tone in the series of time frames including:
determining in a frequency domain, a phase spectrum for each time frame over a plurality of frequency bands,
for each frequency band of the plurality of frequency bands, determining a phase correlation across the determined phase spectra, and
generating a pure tone detection signal in case a predefined phase correlation criterion is met.

2. The method of claim 1, wherein the phase correlation is determined, while accounting for a phase change corresponding to the time interval between each pair of consecutive time frames.

3. The method of claim 1, wherein in case the phase associated with a frequency band is substantially equal across all phase spectra, within a predefined correlation range, a pure tone detection signal is generated.

4. The method of claim 1, further comprising, in case the predefined phase correlation criterion is met for a frequency band, determining a magnitude value for each time frame at said frequency band, and determining a magnitude correlation across the determined magnitude values at said frequency band, and generating the pure tone detection signal only in case a predefined magnitude correlation criterion is met.

5. The method of claim 1, further comprising, in case the pure tone detection signal is generated, interacting with the audio signal in the frequency domain, for determining whether the detected pure tone originates from audio feedback.

6. The method of claim 1, further comprising selectively suppressing the magnitude of the audio signal at said feedback frequency band; monitoring the suppressed magnitude and/or the phase of the audio signal at the feedback frequency band over a further series of time frames; and determining whether the detected pure tone is sustained in the further series of time frames based on the monitored magnitude and/or phase.

7. The method of claim 6, comprising eliminating or relieving the selective suppressing in case the pure tone is sustained.

8. The method of claim 1, wherein the series of time frame signals spans a time period of between 2-50 milliseconds.

9. The method of claim 8, wherein the series of time frame signals includes at least 3 time frame signals.

10. The method of claim 1, wherein each phase spectrum is obtained by a 2N-point Fast Fourier Transform (FFT) of a respective time frame, and divided into N frequency bands.

11. A method of suppressing an audio feedback condition in a wearable audio device, comprising:
detecting an audio feedback condition in the wearable audio device according to-a the method of claim 1; and
in case an audio feedback condition is detected at a frequency band, selectively suppressing the magnitude of the audio signal at said frequency band.

12. The method of claim 11, wherein the magnitude of the audio signal is suppressed at one or more frequency bands adjacent said feedback frequency band.

13. The method of claim 11, wherein the magnitude of the audio signal is suppressed by filtering the audio signal with a notch-filter centered at said feedback frequency band.

14. The method of claim 11, wherein the magnitude at said feedback frequency band is suppressed for a predefined time period, and the suppression is released upon expiry of the predefined time period.

15. The method of claim 11, wherein the suppression is released upon detecting a predetermined maximum number of new audio feedback conditions.

16. The method of claim 15, wherein the maximum number of new audio feedback condition detections is predetermined to be in a predetermined range.

17. The method of claim 15-, wherein the maximum number of new audio feedback condition detections is automatically adjustable.

18. The method of claim 14, wherein the magnitude of the audio signal at said feedback frequency band is permanently suppressed, in case a feedback condition is determined again at a said feedback frequency band within a predefined time period after release of the suppression.

19. The method of claim 18, wherein the suppression tracks a frequency shift of the feedback frequency band.

20. A wearable audio device, comprising an audio feedback detection module configured for executing-a the method of claim 1.

21. The wearable audio device of claim 20, comprising an audio feedback suppression module configured for detecting an audio feedback condition in the wearable audio device, according to a method comprising:
receiving a series of time frames of a time-domain audio signal, each pair of consecutive time frames of the series of time frames being, at least partly, shifted in time by a time interval,
detecting a presence of a pure tone in the series of time frames including:
determining in a frequency domain, a phase spectrum for each time frame over a plurality of frequency bands,
for each frequency band of the plurality of frequency bands, determining a phase correlation across the determined phase spectra, and
generating a pure tone detection signal in case a predefined phase correlation criterion is met and
wherein the audio feedback suppression module configured for, in case an audio feedback condition is detected at a frequency band, selectively suppressing the magnitude of the audio signal at said frequency band.
